(19) United States
(12) Patent Application Publication
(10) Pub. No.: US 2025/0364740 A1
(43) Pub. Date: Nov. 27, 2025

(54) WIRING TERMINAL AND CONDUCTING WIRE

(71) Applicant: Shenzhen Jiading E-commerce Co., LTD, Shenzhen (CN)

(72) Inventors: Yungui ZUO, Shenzhen (CN); Long HU, Shenzhen (CN)

(73) Assignee: Shenzhen Jiading E-commerce Co., LTD, Shenzhen (CN)

(21) Appl. No.: 18/780,287

(22) Filed: Jul. 22, 2024

(30) Foreign Application Priority Data
May 27, 2024 (CN) 202410667862.3

(51) Int. Cl. H01R 11/12; H01R 4/18; H01R 4/48; H02H 9/02

(52) U.S. Cl. CPC H01R 11/12; H01R 4/183; H01R 4/4811; H02H 9/02

(57) ABSTRACT

A wiring terminal includes a metal lug, a current-limiting circuit board, and a metal spring plate. The metal lug is electrically connected to one end of a wire body of the conducting wire. The current-limiting circuit board is configured to limit a magnitude of a current, and is electrically connected to the one end of the wire body of the conducting wire. The metal spring plate is spaced from the metal lug in a first direction. The metal spring plate is electrically connected to the current-limiting circuit board. When the metal lug is pressed, the metal spring plate can be in conduction connection with the metal lug, and a resistance of the metal lug is smaller than that of the current-limiting circuit board. The wiring terminal can resolve a problem of emergence of electric sparks in a wiring process, reduce potential safety hazards, and implement a safe and reliable connection.

### CROSS-REFERENCE TO RELATED APPLICATIONS

This application claims priority to Chinese Patent Application No. 202410667862.3 with a filing date of May 27, 2024. The content of the aforementioned application, including any intervening amendments thereto, is incorporated herein by reference.

### TECHNICAL FIELD

The present disclosure relates to the field of terminal technologies, and in particular to, a wiring terminal and a conducting wire.

### BACKGROUND

A battery and an external device, for example, a charging device, a power supply device or an inverter are usually connected using a conducting wire. The conducting wire includes a wire body and a metal lug disposed on the end of the wire body. The metal lug is configured to connect a battery to a positive or negative electrode of the external device, to transfer electric energy.

However, in the foregoing structure in which the battery is connected to the external device, when the metal lug moves to the electrode end of the battery, it is likely to generate electric field strength between the battery and the external device due to a voltage difference. This leads to electron acceleration and emergence of sparks, and further poses a risk, thereby causing low wiring safety.

### SUMMARY OF PRESENT INVENTION

The embodiments of the present disclosure provide a wiring terminal and a conducting wire, to resolve the problem in the conventional technology that the wiring terminal is poor in safety as sparks are likely to emerge when the wiring terminal is connected to an electrode.

In one aspect, an embodiment of the present disclosure provides a wiring terminal, including:
a metal lug, configured to be electrically connected to one end of a wire body of a conducting wire;
a current-limiting circuit board, configured to limit a magnitude of a current, where the current-limiting circuit board is electrically connected to the one end of the wire body of the conducting wire; and
a metal spring plate spaced from the metal lug in a first direction, where the metal spring plate is electrically connected to the current-limiting circuit board.

When the metal lug is pressed, the metal spring plate is in conduction connection with the metal lug, and a resistance of the metal lug is less than that of the current-limiting circuit board.

In an embodiment, the metal lug includes an edge part away from the wire body, the edge part is provided with a rubber-coated member, and the rubber-coated member protrudes from a side that is of the edge part and that is away from the metal spring plate.

In an embodiment, the rubber-coated member extends along the edge part in the first direction, and protrudes from a side that is of the edge part and that faces the metal spring plate, and when the metal spring plate is in conduction connection with the metal lug, the rubber-coated member is located at a periphery of the metal spring plate.

In an embodiment, the metal lug includes a first lug plate and a crimping ring; in the first direction, the crimping ring is located at a side that is of the first lug plate and that is away from the metal spring plate; and the crimping ring is configured to mount the one end of the wire body, and the first lug plate is connected to a side that is of the crimping ring and that is away from the wire body in a bending manner.

In an embodiment, in the first direction, the metal lug is provided with a first bolt hole, and the metal spring plate is provided with a second bolt hole matched with the first bolt hole, so that a bolt passes through the first bolt hole and the second bolt hole in sequence to achieve fastening.

In an embodiment, a housing and a cover are further included, where one part of the metal lug and one part of the metal spring plate are disposed in the housing, and the other part of the metal lug and the other part of the metal spring plate are exposed to a side of the housing in a second direction; the part the metal lug disposed in the housing is electrically connected to the one end of the wire body; and the cover is movably connected to the housing, so that the cover moves to shield or expose the metal lug and the part of the metal spring plate exposed to the housing, where the second direction is perpendicular to the first direction.

In an embodiment, the cover is slidably connected to the housing in the second direction.

In an embodiment, a sliding structure is further included, including:
a guide slot, provided on one of the housing and the cover, where the guide slot extends in the second direction; and
a boss disposed on the other of the housing and the cover, where the boss is accommodated in the guide slot.

In an embodiment, a limiting structure is further included, including:
a limiting bump, disposed on one of the housing and the cover; and
a limiting slot provided on the other of the housing and the cover, where the limiting bump is accommodated in the limiting slot, and the limiting slot extends in the second direction; and two sides of the limiting slot in the second direction each are provided with a stop wall, and the stop wall abuts against the limiting bump.

In another aspect, an embodiment of the present disclosure further provides a conducting wire, including the wiring terminal in the foregoing embodiments.

Compared with those in the conventional technology, the wiring terminal and the conducting wire provided in the embodiments of the present disclosure have the following beneficial effects: The wiring terminal in the present disclosure can avoid emergence of electric sparks in a wiring process with an electrode of a battery, and is good in safety.

Specifically, in the process in which the metal spring plat infinitely approaches the electrode, as the metal spring plate is connected to the current-limiting circuit board, the current-limiting circuit board can effectively restrain flow of conductive ions in dielectric air between the conducting wire and the electrode. After the metal spring plate is in conduction connection with the electrode, the electrode, the metal spring plate, the current-limiting circuit board, and the wire body form a path. In this case, the current-limiting circuit board can limit an instantaneous current of the electrode in the path, to reduce emergence of electric sparks. In addition, before the metal lug is connected to the electrode of the battery, the metal spring plate can control the metal lug and the electrode to be within a safe distance, thereby avoiding electric sparks generated when the metal lug and the electrode are too close to each other. Then, under external pressure, the metal lug can be in conduction connection with the metal spring plate, so that a line from the metal spring plate to the current-limiting circuit board is connected to a line from the metal lug to the wire body. As the line to the wire body through the current-limiting circuit board has a larger resistance, a current of the electrode basically flows to the wire body through the line from the metal lug to the wire body. In this way, the metal lug is safely connected to the electrode. It can be learned that the wiring terminal in the present disclosure is higher in safety during wiring.

### BRIEF DESCRIPTION OF THE DRAWINGS

The specific implementation of the present disclosure will be further described in detail below with reference to the accompanying drawings and specific embodiments. In the drawings:

FIG. 1 is a first schematic three-dimensional view of a wiring terminal according to an embodiment of the present disclosure;

FIG. 2 is a side view of a wiring terminal according to an embodiment of the present disclosure;

FIG. 3 is a schematic disassembly diagram of a wiring terminal according to an embodiment of the present disclosure;

FIG. 4 is a second schematic three-dimensional view of a wiring terminal according to an embodiment of the present disclosure;

FIG. 5 is a schematic diagram of a circuit of a current-limiting circuit board in Embodiment 1 according to an embodiment of the present disclosure;

FIG. 6 is a schematic diagram of a circuit of a current-limiting circuit board in Embodiment 2 according to an embodiment of the present disclosure;

FIG. 7 is schematic diagram of a circuit of a current-limiting circuit board in Embodiment 3 according to an embodiment of the present disclosure;

FIG. 8 is a schematic assembly diagram of a cover and a housing according to an embodiment of the present disclosure;

FIG. 9 is a schematic disassembly diagram of a cover and a housing according to an embodiment of the present disclosure; and

FIG. 10 is a schematic three-dimensional view of a cover according to an embodiment of the present disclosure.

### DESCRIPTION OF REFERENCE NUMERALS

10: wiring terminal;
100: metal lug; 110: edge part; 120: first bolt hole; 130: first lug plate; 140: crimping ring;
200: current-limiting circuit board;
300: metal spring plate; 310: second bolt hole; 320: second lug plate; 330: fixing plate;
400: rubber-coated member;
500: housing; 510: side cover;
600: cover; 610: anti-skid pattern;
700: sliding structure; 710: boss; 720: guide slot;
800: limiting structure; 810: limiting bump; 820: limiting slot; and
20: wire body.

### DETAILED DESCRIPTION OF THE EMBODIMENTS

It should be noted that the embodiments in the present disclosure and features in the embodiments may be combined with each other in a non-conflicting situation. The preferred embodiment of the present disclosure is described in detail with reference to the accompanying drawings.

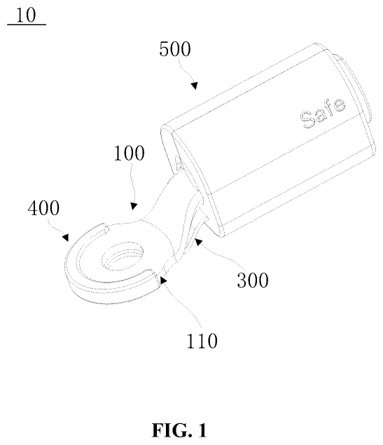

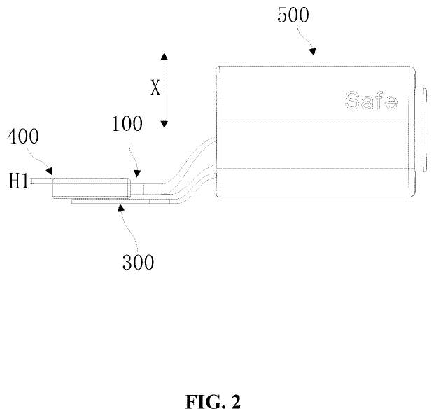

An embodiment of the present disclosure provides a wiring terminal 10. As shown in FIG. 1 to FIG. 3, the wiring terminal 10 provided in this embodiment of the present disclosure includes a metal lug 100, a current-limiting circuit board 200, and a metal spring plate 300. The metal lug 100 is configured to be electrically connected to one end of a wire body 20 of the conducting wire; the current-limiting circuit board 200 is configured to limit a magnitude of a current, and the current-limiting circuit board 200 is electrically connected to the one end of the wire body 20 of the conducting wire; the metal spring plate 300 is spaced from the metal lug 100 in a first direction (an X direction shown in FIG. 2); the metal spring plate 300 is electrically connected to the current-limiting circuit board 200; and when the metal lug 100 is pressed, the metal spring plate 300 is in conduction connection with the metal lug 100. The wiring terminal 10 provided in the present disclosure can resolve a problem of potential safety hazards due to emergence of electric sparks in a wiring process, and implement a safe and reliable connection.

Specifically, in a process in which the metal spring plate 300 infinitely approaches an electrode, as the metal spring plate 300 is connected to the current-limiting circuit board 200, the current-limiting circuit board 200 can effectively restrain flow of conductive ions in dielectric air between the conducting wire and the electrode. After the metal spring plate 300 is in conduction connection with the electrode, the electrode, the metal spring plate 300, the current-limiting circuit board 200, and the wire body 900 form a path. In this case, the current-limiting circuit board 200 can limit an instantaneous current of the electrode in the path, to reduce emergence of electric sparks. In addition, before the metal lug 100 is connected to an electrode of a battery, the metal spring plate 300 can control the metal lug 100 and the electrode to be within a safe distance, thereby avoiding electric sparks generated when the metal lug 100 and the electrode are too close to each other. Under external pressure, the metal lug 100 can be in conduction connection with the metal spring plate 300, so that a line from the metal spring plate 300 to the current-limiting circuit board 200 is connected to a line from the metal lug 100 to the wire body 900. As a line to the wire body 900 through the current-limiting circuit board 200 has a larger resistance, a current of the electrode basically flows to the wire body 900 through the line from the metal lug 100 to the wire body 900. In this way, the metal lug 100 is safely connected to the electrode. It can be learned that the wiring terminal 10 provided in the present disclosure can effectively avoid emergence of electric sparks in a wiring process with the electrode of the battery, and is high in safety.

In the present disclosure, the metal lug 100 can be a copper lug that is widely applied to electronic devices and electrical connections, and can meet connection requirements of different batteries. Similarly, the metal spring plate 300 can be disposed as the metal lug 100. Details are not described herein again.

It should be noted that electric sparks are mainly generated because conductive plasmas are formed through ionization of air. A current is allowed to flow between the conducting wire and the electrode to form arc discharge. Generation of the arc discharge is associated with the dielectric strength of the air, a voltage difference between electrodes, a distance between the conducting wire and the electrode, and an environmental condition (for example, a temperature, humidity, and air pressure). For example, it is prone to emergence of electric sparks when an instantaneous current or voltage for wiring the external device and the battery is especially large or there is a high voltage difference between the external device and the battery. Therefore, the current-limiting circuit board 200 in the present disclosure can preliminarily limit a magnitude of a current, and perform voltage division to a specific extent after the metal spring plate 300 and the metal lug 100 are combined. This reduces a possibility of emergence of electric sparks during wiring.

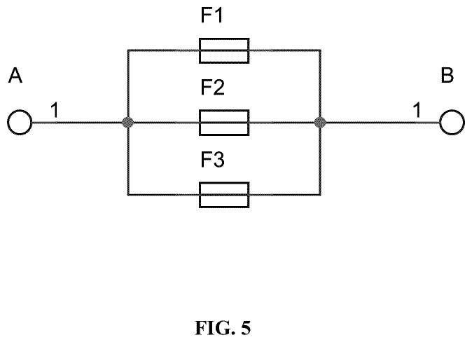

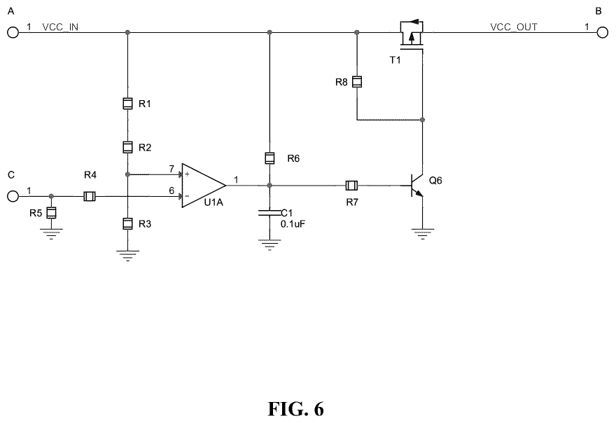

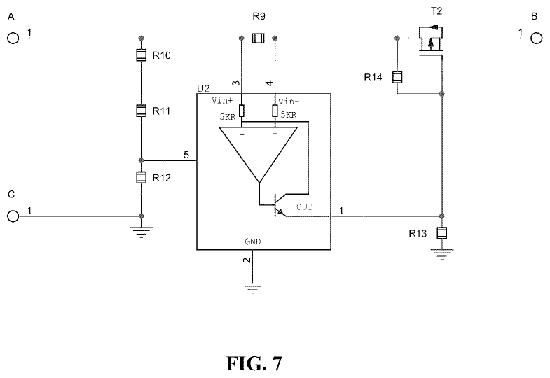

In the present disclosure, the current-limiting circuit board 200 can be disposed in a plurality of manners. With reference to FIG. 5, in Embodiment 1, one end A and one end B are respectively connected to a positive electrode of a battery and a positive electrode of an inverter, and self-recovery fuses (F1, F2, and F3 shown in FIG. 5) are disposed in the current-limiting circuit board 200. When a current exceeds a rated current, resistances of F1 to F3 are increased. If the inverter generates an excessively large current that exceeds the rated current, the resistances of F1 to F3 are increased to limit an output current of the battery. With reference to FIG. 6, in Embodiment 2, one end A and one end B are respectively connected to a positive electrode of a battery and a positive electrode of an inverter, and one end C is connected to a negative electrode of the inverter. Divider resistors (for example, R1, R2 and R3 shown in FIG. 6) and a comparator are disposed in the current-limiting circuit board 200. A standard voltage is obtained through VCC-IN and is output to a pin 7 of the U1A comparator. During normal working, a voltage at the pin 7 of the U1A comparator is higher than that at a pin 6. In this case, a pin 1 outputs a high-level voltage, and Q6 is turned on to normally drive T1, so that the circuit normally works. When an overcurrent occurs, a voltage of R5 is increased and the voltage at the pin 6 of the U1A comparator is increased accordingly. When the voltage at the pin 6 is higher than the voltage at the pin 7, the pin 1 outputs a low-level voltage, Q6 is turned off and T1 is turned off, to achieve a current-limiting effect. With reference to FIG. 7, in Embodiment 3, U2 serves as an electronic switch during a current sampling period, T2 is a MOS transistor, and R10, R11, and R12 are resistors. A voltage is divided by the resistors to supply power to U2. R9 is a sampling resistor, and R13 and R14 are divider resistors, so that a voltage Vgs is greater than a threshold value of T1. In this case, T1 is in an on state during normal working, a current flowing through R9 is within a rated range, and a pin of U2 outputs no voltage. When the current exceeds a limit value, that is, when an overcurrent occurs, voltages at two ends of R9 are increased, a pin 1 of U2 outputs a voltage, an upper-end voltage of R3 is increased, the voltage Vgs is lower than the threshold value, and T1 is turned off, to achieve a current-limiting effect.

Referring to FIG. 1 to FIG. 3, in some embodiments, the metal lug 100 includes an edge part 110 away from the wire body 20, the edge part 110 is provided with a rubber-coated member 400, and the rubber-coated member 400 protrudes from a side that is of the edge part 110 and that is away from the metal spring plate 300. The rubber-coated member 400 can achieve an insulation effect to avoid emergence of electric sparks generated when the metal lug 100 is first in conduction connection with the electrode due to a manual mis-operation, and can improve use safety. The edge part 110 is provided with the rubber-coated member 400, so that a possibility that the metal lug 100 is in direct contact with the electrode can be reduced. In addition, when a reverse side of the metal lug 100 is in conduction connection with the electrode due to carelessness of an operator, the rubber-coated member 400 protruding from the side the edge part 110 away from the metal spring plate 300 can prevent the electrode from being in conduction connection with the metal lug 100. This ensures that the wiring terminal 10 can be connected to the electrode in a correct mounting direction, and avoids a safety problem due to a potential mis-operation.

Specifically, the rubber-coated member 400 extends in a circumferential direction of the edge part 110, to reduce a possibility that when the wiring terminal 10 is connected, the metal lug 100 is in conduction connection with the electrode due to different mounting angles.

It should be noted that in the first direction, a height (H1 shown in FIG. 2) of the rubber-coated member 400 protruding from the side that is of the edge part 110 and that is away from the metal spring plate 300 is greater than a preset height. The preset height is a distance for generating sparks between the electrode and the metal lug 100. This design ensures that the protruded height of the rubber-coated member 400 extends the distance for generating sparks. Therefore, even though the operator operates mistakenly and reversely connects the wiring terminal 10, an enough gap is still kept between the metal lug 100 and the electrode to prevent emergence of sparks. For example, the protruded height is 1 mm.

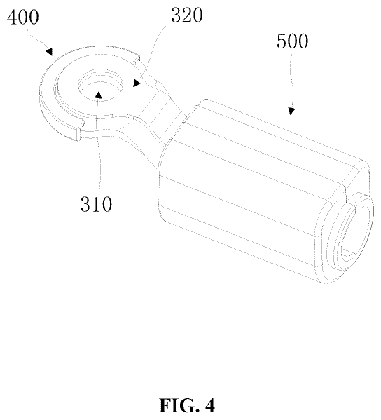

Referring to FIG. 2 and FIG. 4, in some embodiments, the rubber-coated member 400 protrudes from a side that is of the edge part 110 and that faces the metal spring plate 300. When the metal spring plate 300 is in conduction connection with the metal lug 100, the rubber-coated member 400 is located at a periphery of the metal spring plate 300. The rubber-coated member 400 extends along the edge part 110 in a first direction, to completely cover the edge part 110, so that the edge part 110 can be prevented from being in conduction connection with the electrode when the wiring terminal 10 is mounted at an angle of inclination, and use safety is improved. In addition, when the wiring terminal 10 is mounted, based on an operation habit, the operator usually mounts a side that is of the wiring terminal 10 and that is away from the wire body 20 at a specific angle for wiring. The rubber-coated member 400 protrudes from a side that is of the edge part 110 and that faces the metal spring plate 300, so that the electrode can be prevented from being in conduction connection with one end face adjacent to the edge part 110. In this way, when the operator mounts the wiring terminal 10 at a specific angle of inclination, it is difficult for the electrode to be in direct contact with the metal lug 100 without passing through the metal spring plate 300, and therefore, mounting at a specific angle is not required. This reduces operation difficulty and makes mounting more convenient.

Specifically, the rubber-coated member 400 extends in a circumferential direction around the metal spring plate 300 to prevent the electrode from being in conduction connection with the metal lug 100 through a gap between the rubber-coated member 400 and the metal spring plate 300.

It should be noted that a distance for generating sparks is associated with breakdown electric field strength of air. However, the breakdown electric field strength of the air is not a constant value, and is affected by various factors such as air pressure, a temperature and humidity. Therefore, in this embodiment, a value of the preset height is a freely variable value. A person of skill in the art can adjust the preset height according to an actual application scenario and an actual environmental condition. This is not further limited herein.

In an embodiment, the metal lug 100 includes a first lug plate 130 and a crimping ring 140. In the first direction, the crimping ring 140 is located at a side that is of the first lug plate 130 and that is away from the metal spring plate 300; the crimping ring 140 is configured to mount the one end of the wire body 20; and the first lug plate 130 is connected to a side that is of the crimping ring 140 and that is away from the wire body 20. In this way, the first lug plate 130 is connected to the crimping ring 140 in a bending manner, so that the first lug plate 130 is more prone to elastic deformation under pressure relative to the crimping ring 140, and therefore, it is convenient for the first lug plate 130 to be in conduction connection with the metal spring plate 300.

Similarly, the metal spring plate 300 includes a second lug plate 320 and a fixing plate 330, the second lug plate 320 is connected to the fixing plate 330 in a bending manner, and the second lug plate 320 is disposed opposite to the first lug plate 130, so that the second lug plate 320 can be elastically deformed under counter-acting force relative to the fixing plate 330, and is further in conduction connection with the first lug plate 130. This makes connection reliability of the wiring terminal 10 better.

Preferably, a bending angle for the first lug plate 130 and the crimping ring 140 is greater than a bending angle for the second lug plate 320 and the fixing plate 330, so that the first lug plate 130 is more likely to move to be in conduction connection with the second plug plate 320 under pressure relative to the crimping ring 140.

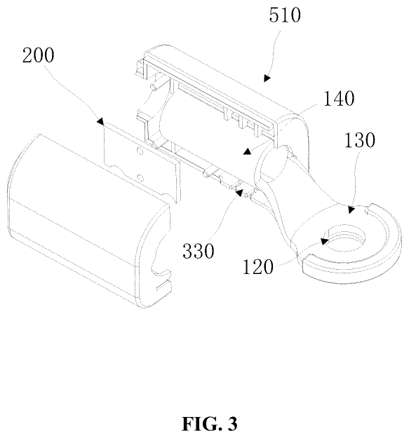

Refer to FIG. 3 and FIG. 4. In an embodiment, in the first direction, the metal lug 100 is provided with a first bolt hole 120, and the metal spring plate 300 is provided with a second bolt hole 310 matched with the first bolt hole 120, so that a bolt can pass through the first bolt hole 120 and the second bolt hole 310 in sequence to achieve fastening. In this way, the wiring terminal 10 is fastened through the bolt, so that the wiring terminal 10 is connected securely and is convenient to operate.

Specifically, the bolt includes a head and a rod. The rod passes through the first bolt hole 120 and the second bolt hole 310 and is in a threaded connection to the electrode. Pressure is applied to the metal lug 100 through the head, so that the metal lug 100 is in conduction connection with the metal spring plate 300. Fastening force of the bolt can keep the metal lug 100 to be not separated from the metal spring plate 300, thereby ensuring connection reliability and stability.

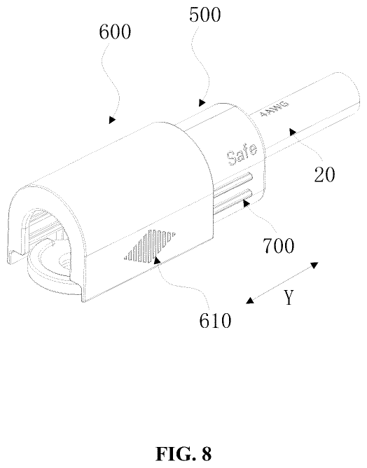

Refer to FIG. 1 to FIG. 4. In an embodiment, the wiring terminal 10 further includes a housing 500. One part of the metal lug 100 and one part of the metal spring plate 300 are arranged on the housing 500, and the other part of the metal lug 100 and the other part of the metal spring plate 300 are exposed to a side of the housing 500 in a second direction (a Y direction shown in FIG. 8). A part that is of the metal lug 100 and that is located inside the housing 500 is electrically connected to the one end of the wire body 20. The housing 500 can limit and fasten the metal lug 100 and the metal spring plate 300, to avoid impact on a connection effect due to deviation of the metal lug 100 and the metal spring plate 300.

Specifically, the metal lug 100 includes a first lug plate 130 and a crimping ring 140, the first lug plate 130 is located outside the housing 500, the crimping ring 140 and the wire body 20 are connected and arranged in the housing 500, and the first lug plate 130 is connected to the crimping ring 140 in a bending manner. The metal spring plate 300 includes a second lug plate 320 and a fixing plate 330, the fixing plate 330 is connected to the housing 500 in a clamping or threaded connection manner, and the second lug plate 320 and the first lug plate 130 are disposed correspondingly to facilitate contact between the two.

In this embodiment, the current-limiting circuit board 200 is also disposed in the housing 500, to protect the current-limiting circuit board 200 from external collision.

In this embodiment, the housing 500 includes side covers 510 that are disposed opposite to each other. The two side covers 510 are detachably connected to facilitate mounting of the metal spring plate 300, the metal lug 100, and the current-limiting circuit board 200.

Further, refer to FIG. 8. The wiring terminal 10 further includes a cover 600. The cover 600 is movably connected to the housing 500, so that the cover 600 can move to shield or expose the metal lug 100, and the part that is of the metal spring plate 300 and that is exposed to the housing 500. In this way, after the wiring terminal 10 is mounted, the cover 600 can shield the metal lug 100 and the metal spring plate 300 while needed, to avoid an accidental touch of the operator and protect the metal lug 100 and the metal spring plate 300 from being externally damaged.

Preferably, anti-skid patterns 610 are further disposed outside the cover 600, to increase contact frictional force, and facilitate grabbing of the operator.

The cover 600 is movably connected to the housing 500 in a plurality of manners. For example, the cover 600 may shield or expose the metal lug 100 and the metal spring plate 300 in a flipping manner. For another example, the cover 600 is movably connected to the housing 500 in a second direction. The cover 600 slides to shield or expose the metal lug 100 and the metal spring plate 300.

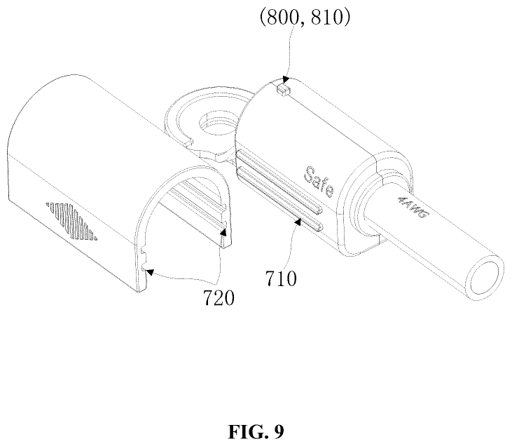

Further, refer to FIG. 8 and FIG. 9. The wiring terminal 10 further includes a sliding structure 700 that includes a guide slot 720 and a boss 710. The guide slot 720 is provided on one of the housing 500 and the cover 600, and the guide slot 720 extends in the second direction. The boss 710 is disposed on the other of the housing 500 and the cover 600, and is accommodated in the guide slot 720. The guide slot 720 can guide the boss 710, so that the boss 710 can slide in the second direction, and the cover 600 is less likely to have an interference with another part when the cover 600 slides smoothly.

Specifically, a plurality of guide slots 720 and a plurality of bosses 710 may be disposed. For example, in this embodiment, there are two guide slots 720 and two bosses 710. The two guide slots 720 are symmetrically disposed on left and right sides of the cover 600, and the two bosses 710 are disposed on the housing 500 and correspond to the corresponding guide slots 720, so that the cover 600 slides more stably.

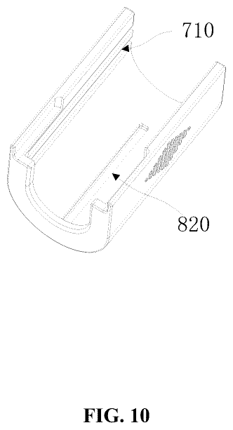

Refer to FIG. 9 and FIG. 10. In an embodiment, a limiting structure 800 is further included. The limiting structure 800 includes a limiting bump 810 and a limiting slot, and the limiting bump 810 is disposed on one of the housing 500 and the cover 600. The limiting slot is provided on the other of the housing 500 and the cover 600, the limiting bump 810 is accommodated in the limiting slot, and the limiting slot extends in the second direction. In addition, two sides of the limiting slot in the second direction each are provided with a stop wall, and the stop wall abuts against the limiting bump 810. This prevents the housing 500 from being separated from the cover 600, and improves reliability of the wiring terminal 10.

Specifically, the limiting bump 810 is disposed on a top of the housing 500, the limiting slot is provided in the cover 600, and corresponds to the limiting bump 810. The limiting structure 800 on the top and the sliding structures 700 on the two sides of the housing 500 can be combined, to further improve stability and reliability of a slidable connection of the cover 600, and ensure that the cover 600 can smoothly slide to a correct position.

An embodiment of the present disclosure further provides a conducting wire, including the wiring terminal 10 in the foregoing embodiments. Beneficial effects of the conducting wire have been recorded in the foregoing embodiments. This is not limited in this embodiment.

It should be understood that the above embodiments are only used to explain the technical solution of the present disclosure, not to limit it. For those skilled in the art, the technical solution recorded in the above embodiments may be modified or some of the technical features may be replaced equivalently. All such modifications and substitutions shall fall within the scope of protection of the appended claims of the present disclosure.

What is claimed is:

1. A wiring terminal, applicable to a conducting wire, comprising:
a metal lug, configured to be electrically connected to one end of a wire body of the conducting wire;
a current-limiting circuit board, configured to limit a magnitude of a current, wherein the current-limiting circuit board is electrically connected to the one end of the wire body of the conducting wire; and
a metal spring plate spaced from the metal lug in a first direction, wherein the metal spring plate is electrically connected to the current-limiting circuit board, wherein
when the metal lug is pressed, the metal spring plate is in conduction connection with the metal lug.

2. The wiring terminal according to claim 1, wherein the metal lug comprises an edge part away from the wire body, the edge part is provided with a rubber-coated member, and the rubber-coated member protrudes from a side that is of the edge part and that is away from the metal spring plate.

3. The wiring terminal according to claim 2, wherein the rubber-coated member protrudes from a side that is of the edge part and that faces the metal spring plate, and when the metal spring plate is in conduction connection with the metal lug, the rubber-coated member is located at a periphery of the metal spring plate.

4. The wiring terminal according to claim 1, wherein the metal lug comprises a first lug plate and a crimping ring; in the first direction, the crimping ring is located at a side that is of the first lug plate and that is away from the metal spring plate; and the crimping ring is configured to mount the one end of the wire body, and the first lug plate is connected to a side that is of the crimping ring and that is away from the wire body in a bending manner.

5. The wiring terminal according to claim 1, wherein in the first direction, the metal lug is provided with a first bolt hole, and the metal spring plate is provided with a second bolt hole matched with the first bolt hole, so that a bolt passes through the first bolt hole and the second bolt hole in sequence to achieve fastening.

6. The wiring terminal according to claim 1, further comprising a housing and a cover, wherein one part of the metal lug and one part of the metal spring plate are disposed in the housing, and the other part of the metal lug and the other part of the metal spring plate are exposed to a side of the housing in a second direction; the part of the metal lug disposed in the housing is electrically connected to the one end of the wire body; and the cover is movably connected to the housing, so that the cover moves to shield or expose the metal lug and the part of the metal spring plate exposed to the housing, wherein the second direction is perpendicular to the first direction.

7. The wiring terminal according to claim 2, further comprising a housing and a cover, wherein one part of the metal lug and one part of the metal spring plate are disposed in the housing, and the other part of the metal lug and the other part of the metal spring plate are exposed to a side of the housing in a second direction; the part of the metal lug disposed in the housing is electrically connected to the one end of the wire body; and the cover is movably connected to the housing, so that the cover moves to shield or expose the metal lug and the part of the metal spring plate exposed to the housing, wherein the second direction is perpendicular to the first direction.

8. The wiring terminal according to claim 3, further comprising a housing and a cover, wherein one part of the metal lug and one part of the metal spring plate are disposed in the housing, and the other part of the metal lug and the other part of the metal spring plate are exposed to a side of the housing in a second direction; the part of the metal lug disposed in the housing is electrically connected to the one end of the wire body; and the cover is movably connected to the housing, so that the cover moves to shield or expose the metal lug and the part of the metal spring plate exposed to the housing, wherein the second direction is perpendicular to the first direction.

9. The wiring terminal according to claim 4, further comprising a housing and a cover, wherein one part of the metal lug and one part of the metal spring plate are disposed in the housing, and the other part of the metal lug and the other part of the metal spring plate are exposed to a side of the housing in a second direction; the part of the metal lug disposed in the housing is electrically connected to the one end of the wire body; and the cover is movably connected to the housing, so that the cover moves to shield or expose the metal lug and the part of the metal spring plate exposed to the housing, wherein the second direction is perpendicular to the first direction.

10. The wiring terminal according to claim 5, further comprising a housing and a cover, wherein one part of the metal lug and one part of the metal spring plate are disposed in the housing, and the other part of the metal lug and the other part of the metal spring plate are exposed to a side of the housing in a second direction; the part of the metal lug disposed in the housing is electrically connected to the one end of the wire body; and the cover is movably connected to the housing, so that the cover moves to shield or expose the metal lug and the part of the metal spring plate exposed to the housing, wherein the second direction is perpendicular to the first direction.

11. The wiring terminal according to claim 6, wherein the cover is slidably connected to the housing in the second direction.

12. The wiring terminal according to claim 11, further comprising a sliding structure, wherein the sliding structure comprises:
a guide slot, provided on one of the housing and the cover, wherein the guide slot extends in the second direction; and
a boss, disposed on the other of the housing and the cover, wherein the boss is accommodated in the guide slot.

13. The wiring terminal according to claim 12, further comprising a limiting structure, wherein the limiting structure comprises:
a limiting bump, disposed on one of the housing and the cover; and
a limiting slot, provided on the other of the housing and the cover, wherein the limiting bump is accommodated in the limiting slot, and the limiting slot extends in the second direction; and two sides of the limiting slot in the second direction each are provided with a stop wall, and the stop wall abuts against the limiting bump.

14. A conducting wire, comprising the wiring terminal according to claim 1.

15. A conducting wire, comprising the wiring terminal according to claim 2.

16. A conducting wire, comprising the wiring terminal according to claim 3.

17. A conducting wire, comprising the wiring terminal according to claim 4.

18. A conducting wire, comprising the wiring terminal according to claim 5.

19. A conducting wire, comprising the wiring terminal according to claim 6.

20. A conducting wire, comprising the wiring terminal according to claim 11.
